(19) United States
(12) Patent Application Publication
(10) Pub. No.: US 2003/0061464 A1
(43) Pub. Date: Mar. 27, 2003

(54) Digital signal controller instruction set and architecture

(76) Inventors: Michael I. Catherwood, Pepperell, MA (US); Brian Boles, Mesa, AZ (US); Stephen A. Bowling, Chandler, AZ (US); Joshua M. Conner, Apache Junction, AZ (US); Rodney Drake, Mesa, AZ (US); John Elliot, Chandler, AZ (US); Brian Neil Fall, Chandler, AZ (US); James H. Grosbach, Scottsdale, AZ (US); Tracy Ann Kuhrt, Mesa, AZ (US); Guy McCarthy, Chandler, AZ (US); Manuel Muro JR., Chandler, AZ (US); Michael Pyska, Phoenix, AZ (US); Joseph W. Triece, Phoenix, AZ (US)

Correspondence Address: SWIDLER BERLIN SHEREFF FRIEDMAN, LLP, 3000 K STREET, NW, BOX IP, WASHINGTON, DC, 20007, US

(21) Appl. No.: 09/870,457

(22) Filed: Jun. 1, 2001

(51) Int. Cl. G06F 15/00

(52) U.S. Cl. 712/35

(57) ABSTRACT

An instruction set is provided that features ninety four instructions and various address modes to deliver a mixture of flexible micro-controller like instructions and specialized digital signal processor (DSP) instructions that execute from a single instruction stream.

### CROSS REFERENCE TO RELATED APPLICATIONS

This application is related to the following applications: U.S. application for “Repeat Instruction with Interrupt” on Jun. 1, 2001 by M. Catherwood, et al. (MTI-1665); U.S. application for “Low Overhead Interrupt” on Jun. 1, 2001 by M. Catherwood, et al. (MTI-1666); U.S. application for “Find First Bit Value Instructions” on Jun. 1, 2001 by M. Catherwood (MTI-1667); U.S. application for “Bit Replacement and Extraction Instructions” on Jun. 1, 2001 by B. Boles, et al. (MTI-1668); U.S. application for “Shadow Register Array Control Instructions” on Jun. 1, 2001 by M. Catherwood, et al. (MTI-1669); U.S. application for “Multi-Precision Barrel Shifting” on Jun. 1, 2001 by J. Conner, et al. (MTI-1670); U.S. application for “Dynamically Reconfigurable Data Space” on Jun. 1, 2001 by M. Catherwood, et al. (MTI-1735); U.S. application for “Modified Harvard Architecture Processor Having Data Memory Space Mapped to Program Memory Space” on Jun. 1, 2001 by J. Grosbach, et al. (MTI-1736); U.S. application for “Modified Harvard Architecture Processor Having Data Memory Space Mapped to Program Memory Space with Erroneous Execution Protection” on Jun. 1, 2001 by M. Catherwood (MTI-1737); U.S. application for “Dual Mode Arithmetic Saturation Processing” on Jun. 1, 2001 by M. Catherwood (MTI-1738); U.S. application for “Compatible Effective Addressing With a Dynamically Reconfigurable Data Space Word Width” on Jun. 1, 2001 by M. Catherwood, et al. (MTI-1739); U.S. application for “Maximally Negative Signed Fractional Number Multiplication” on Jun. 1, 2001 by M. Catherwood (MTI-1754); U.S. application for “Euclidean Distance Instructions” on Jun. 1, 2001 by M. Catherwood (MTI-1755); U.S. application for “Sticky Z Bit” on Jun. 1, 2001 by J. Elliot (MTI-1756); U.S. application for “Variable Cycle Interrupt Disabling” on Jun. 1, 2001 by B. Boles, et al. (MTI-1757); U.S. application for “Register Pointer Trap” on Jun. 1, 2001 by M. Catherwood (MTI-1758); U.S. application for “Modulo Addressing Based on Absolute Offset” on Jun. 1, 2001 by M. Catherwood (MTI-1759); U.S. application for “Dual Dead Time Unit for PWM Module” on Jun. 1, 2001 by S. Bowling (MTI-1789); U.S. application for “Fault Pin Priority” on Jun. 1, 2001 by S. Bowling (MTI-1790); U.S. application for “Extended Resolution Mode for PWM Module” on Jun. 1, 2001 by S. Bowling (MTI-1791); U.S. application for “Configuration Fuses for Setting PWM Options” on Jun. 1, 2001 by S. Bowling (MTI-1792); U.S. application for “Automatic A/D Sample Triggering” on Jun. 1, 2001 by B. Boles (MTI-1794); U.S. application for “Reduced Power Option” on Jun. 1, 2001 by M. Catherwood (MTI-1796) which are all hereby incorporated herein by reference for all purposes.

### FIELD OF THE INVENTION

The present invention relates generally to processor instruction sets and, more particularly, to an instruction set for processing micro-controller type instructions and digital signal processor instructions from a single instruction stream.

### BACKGROUND OF THE INVENTION

Processors, including microprocessors, digital signal processors and microcontrollers, operate by running software programs that are embodied in one or more series of instructions stored in a memory. The processors run the software by fetching the instructions from the series of instructions, decoding the instructions and executing them.

In addition to program instructions, data is also stored in memory that is accessible by the processor. Generally, the program instructions process data by accessing data in memory, modifying the data and storing the modified data into memory.

The instructions themselves also control the sequence of functions that the processor performs and the order in which the processor fetches and executes the instructions. For example, the order for fetching and executing each instruction may be inherent in the order of the instructions within the series. Alternatively, instructions such as branch instructions, conditional branch instructions, subroutine calls and other flow control instructions may cause instructions to be fetched and executed out of the inherent order of the instruction series.

The program instructions that comprise a software program are taken from an instruction set that is designed for each processor. The instruction set includes a plurality of instructions, each of which specifies operations of one or more functional components of the processor. The instructions are decoded in an instruction decoder which generates control signals distributed to the functional components of the processor to perform the operation(s) specified in the instruction.

The instruction set itself, in terms of breadth, flexibility and simplicity dictates the ease with which programmers may generate programs. The instruction set also reflects the processor architecture and accordingly the functional and performance capability of the processor.

There is a need for a processor and an instruction set that includes a robust and an efficient set of instructions for a wide variety of applications. Given the rapid growth of digital signal processing (DSP) applications, there is a further need for an instruction set that incorporates DSP type instructions and micro-controller type instructions. There is a further need to provide processor having a tightly coupled DSP engine and a microcontroller arithmetic logic unit (ALU) for many types of applications conventionally handled separately by either a microcontroller or a digital signal processor, including motor control, soft modems, automotive body computers, speech recognition, echo cancellation and fingerprint recognition.

### SUMMARY OF THE INVENTION

According to embodiments of the present invention, an instruction set is provided that features ninety four instructions and eleven address modes to deliver a mixture of flexible micro-controller like instructions and specialized digital signal processor (DSP) instructions that execute from a single instruction stream.

According to an embodiment of the present invention, a processor executes instructions within the designated instruction set. The processor includes a program memory, a program counter, registers and at least one execution unit. The program memory stores program instructions, including instructions from the designated instruction set. The program counter determines the current instruction for processing. The registers store operand data specified by the program instructions and the execution unit(s) execute the current instruction. The execution unit may include a DSP engine and arithmetic logic unit. Each designated instruction is identified to the processor by designated encoding and to programmers by a designated mnemonic.

### BRIEF DESCRIPTION OF THE FIGURES

The above described features and advantages of the present invention will be more fully appreciated with reference to the detailed description and appended figures in which:

FIG. 1 depicts a functional block diagram of an embodiment of a processor chip within which embodiments of the present invention may find application.

FIG. 2 depicts a functional block diagram of a data busing scheme for use in a processor, which has a microcontroller and a digital signal processing engine, within which embodiments of the present invention may find application.

FIG. 3 depicts a functional block diagram of a digital signal processor (DSP) engine according to an embodiment of the present invention.

FIGS. 4A-4E depict five different instruction flow types according to embodiments of the present invention.

FIG. 5 depicts a programmer's model of the processor according to an embodiment of the present invention.

### DETAILED DESCRIPTION

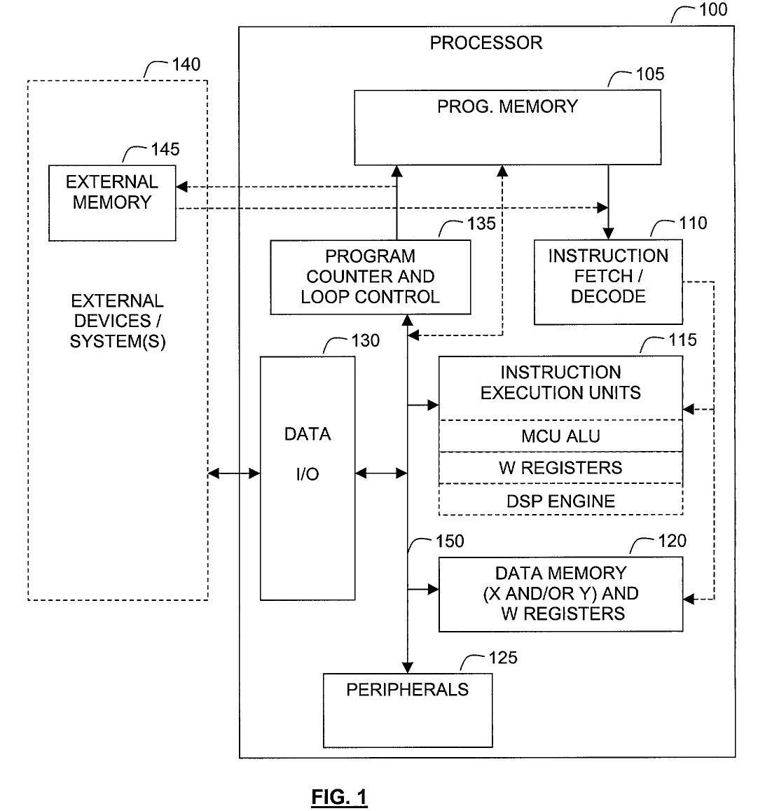

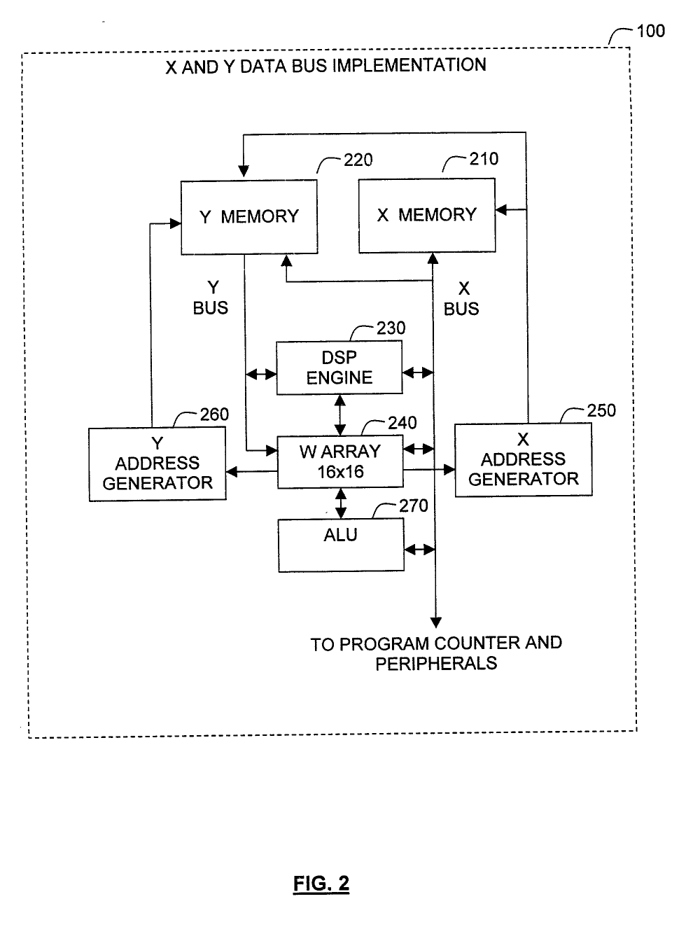

In order to describe the instruction set and its relationship to a processor for executing the instruction set, an overview of pertinent processor elements is first presented with reference to FIGS. 1 and 2. The overview section describes the process of fetching, decoding and executing program instructions taken from the instruction set according to embodiments of the present invention.

Overview of Processor Elements

FIG. 1 depicts a functional block diagram of an embodiment of a processor chip within which the present invention may find application. Referring to FIG. 1, a processor 100 is coupled to external devices/systems 140. The processor 100 may be any type of processor including, for example, a digital signal processor (DSP), a microprocessor, a microcontroller or combinations thereof. The external devices 140 may be any type of systems or devices including input/output devices such as keyboards, displays, speakers, microphones, memory, or other systems which may or may not include processors. Moreover, the processor 100 and the external devices 140 may together comprise a stand alone system.

The processor 100 includes a program memory 105, an instruction fetch/decode unit 110, instruction execution units 115, data memory and registers 120, peripherals 125, data I/O 130, and a program counter and loop control unit 135. The bus 150, which may include one or more common buses, communicates data between the units as shown.

The program memory 105 stores software embodied in program instructions for execution by the processor 100. The program memory 105 may comprise any type of nonvolatile memory such as a read only memory (ROM), a programmable read only memory (PROM), an electrically programmable or an electrically programmable and erasable read only memory (EPROM or EEPROM) or flash memory. In addition, the program memory 105 may be supplemented with external nonvolatile memory 145 as shown to increase the complexity of software available to the processor 100. Alternatively, the program memory may be volatile memory which receives program instructions from, for example, an external non-volatile memory 145. When the program memory 105 is nonvolatile memory, the program memory may be programmed at the time of manufacturing the processor 100 or prior to or during implementation of the processor 100 within a system. In the latter scenario, the processor 100 may be programmed through a process called in-line serial programming.

The instruction fetch/decode unit 110 is coupled to the program memory 105, the instruction execution units 115 and the data memory 120. Coupled to the program memory 105 and the bus 150 is the program counter and loop control unit 135. The instruction fetch/decode unit 110 fetches the instructions from the program memory 105 specified by the address value contained in the program counter 135. The instruction fetch/decode unit 110 then decodes the fetched instructions and sends the decoded instructions to the appropriate execution unit 115. The instruction fetch/decode unit 110 may also send operand information including addresses of data to the data memory 120 and to functional elements that access the registers.

The program counter and loop control unit 135 includes a program counter register (not shown) which stores an address of the next instruction to be fetched. During normal instruction processing, the program counter register may be incremented to cause sequential instructions to be fetched. Alternatively, the program counter value may be altered by loading a new value into it via the bus 150. The new value may be derived based on decoding and executing a flow control instruction such as, for example, a branch instruction. In addition, the loop control portion of the program counter and loop control unit 135 may be used to provide repeat instruction processing and repeat loop control as further described below.

The instruction execution units 115 receive the decoded instructions from the instruction fetch/decode unit 110 and thereafter execute the decoded instructions. As part of this process, the execution units may retrieve one or two operands via the bus 150 and store the result into a register or memory location within the data memory 120. The execution units may include an arithmetic logic unit (ALU) such as those typically found in a microcontroller. The execution units may also include a digital signal processing engine, a floating point processor, an integer processor or any other convenient execution unit. A preferred embodiment of the execution units and their interaction with the bus 150, which may include one or more buses, is presented in more detail below with reference to FIG. 2.

The data memory and registers 120 are volatile memory and are used to store data used and generated by the execution units. The data memory 120 and program memory 105 are preferably separate memories for storing data and program instructions respectively. This format is a known generally as a Harvard architecture. It is noted, however, that according to the present invention, the architecture may be a Von-Neuman architecture or a modified Harvard architecture which permits the use of some program space for data space. A dotted line is shown, for example, connecting the program memory 105 to the bus 150. This path may include logic for aligning data reads from program space such as, for example, during table reads from program space to data memory 120.

Referring again to FIG. 1, a plurality of peripherals 125 on the processor may be coupled to the bus 125. The peripherals may include, for example, analog to digital converters, timers, bus interfaces and protocols such as, for example, the controller area network (CAN) protocol or the Universal Serial Bus (USB) protocol and other peripherals. The peripherals exchange data over the bus 150 with the other units.

The data I/O unit 130 may include transceivers and other logic for interfacing with the external devices/systems 140. The data I/O unit 130 may further include functionality to permit in circuit serial programming of the Program memory through the data I/O unit 130.

FIG. 2 depicts a functional block diagram of a data busing scheme for use in a processor 100, such as that shown in FIG. 1, which has an integrated microcontroller arithmetic logic unit (ALU) 270 and a digital signal processing (DSP) engine 230. This configuration may be used to integrate DSP functionality to an existing microcontroller core. Referring to FIG. 2, the data memory 120 of FIG. 1 is implemented as two separate memories: an X-memory 210 and a Y-memory 220, each being respectively addressable by an X-address generator 250 and a Y-address generator 260. The X-address generator may also permit addressing the Y-memory space thus making the data space appear like a single contiguous memory space when addressed from the X address generator. The bus 150 may be implemented as two buses, one for each of the X and Y memory, to permit simultaneous fetching of data from the X and Y memories.

The W registers 240 are general purpose address and/or data registers. The DSP engine 230 is coupled to both the X and Y memory buses and to the W registers 240. The DSP engine 230 may simultaneously fetch data from each the X and Y memory, execute instructions which operate on the simultaneously fetched data and write the result to an accumulator (not shown) and write a prior result to X or Y memory or to the W registers 240 within a single processor cycle.

In one embodiment, the ALU 270 may be coupled only to the X memory bus and may only fetch data from the X bus. However, the X and Y memories 210 and 220 may be addressed as a single memory space by the X address generator in order to make the data memory segregation transparent to the ALU 270. The memory locations within the X and Y memories may be addressed by values stored in the W registers 240.

Any processor clocking scheme may be implemented for fetching and executing instructions. A specific example follows, however, to illustrate an embodiment of the present invention. Each instruction cycle is comprised of four Q clock cycles Q1-Q4. The four phase Q cycles provide timing signals to coordinate the decode, read, process data and write data portions of each instruction cycle.

According to one embodiment of the processor 100, the processor 100 concurrently performs two operations—it fetches the next instruction and executes the present instruction. Accordingly, the two processes occur simultaneously. The following sequence of events may comprise, for example, the fetch instruction cycle:

| | |
|---|---|
| Q1: | Fetch Instruction |
| Q2: | Fetch Instruction |
| Q3: | Fetch Instruction |
| Q4: | Latch Instruction into prefetch register, Increment PC |

The following sequence of events may comprise, for example, the execute instruction cycle for a single operand instruction:

| | |
|---|---|
| Q1: | latch instruction into IR, decode and determine addresses of operand data |
| Q2: | fetch operand |
| Q3: | execute function specified by instruction and calculate destination address for data |
| Q4: | write result to destination |

The following sequence of events may comprise, for example, the execute instruction cycle for a dual operand instruction using a data pre-fetch mechanism. These instructions pre-fetch the dual operands simultaneously from the X and Y data memories and store them into registers specified in the instruction. They simultaneously allow instruction execution on the operands fetched during the previous cycle.

| | |
|---|---|
| Q1: | latch instruction into IR, decode and determine |
| | addresses of operand data |
| Q2: | pre-fetch operands into specified registers, |
| | execute operation in instruction |
| Q3: | execute operation in instruction, |
| | calculate destination address for data |
| Q4: | complete execution, write result to destination |

DSP Engine

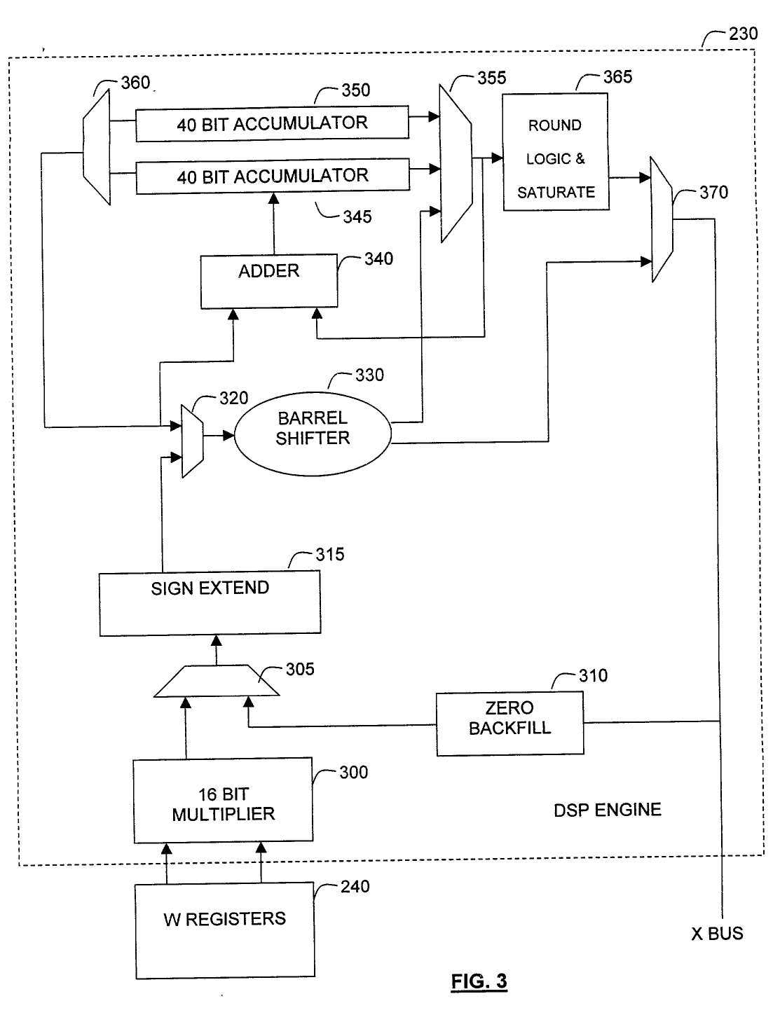

FIG. 3 depicts a functional block diagram of the DSP engine 230. The DSP engine executes various instructions within the instruction set according to embodiments of the present invention. The DSP engine 230 is coupled to the X and the Y bus and the W registers 240. The DSP engine includes a multiplier 300, a barrel shifter 330, an adder/subtractor 340, two accumulators 345 and 350 and round and saturation logic 365. These elements and others that are discussed below with reference to FIG. 3 cooperate to process DSP instructions including, for example, multiply and accumulate instructions and shift instructions. According to one embodiment of the invention, the DSP engine operates as an asynchronous block with only the accumulators and the barrel shifter result registers being clocked. Other configurations, including pipelined configurations, may be implemented according to the present invention.

The multiplier 300 has inputs coupled to the W registers 240 and an output coupled to the input of a multiplexer 305. The multiplier 300 may also have inputs coupled to the X and Y bus. The multiplier may be any size however, for convenience, a 16×16 bit multiplier is described herein which produces a 32 bit output result. The multiplier may be capable of signed and unsigned operation and can multiplex its output using a scaler to support either fractional or integer results.

The output of the multiplier 300 is coupled to one input of a multiplexer 305. The multiplexer 305 has another input coupled to zero backfill logic 310, which is coupled to the X Bus. The zero backfill logic 310 is included to illustrate that 16 zeros may be concatenated onto the 16 bit data read from the X bus to produce a 32 bit result fed into the multiplexer 305. The 16 zeros are generally concatenated into the least significant bit positions.

The multiplexer 305 includes a control signal controlled by the instruction decoder of the processor which determines which input, either the multiplier output or a value from the X bus is passed forward. For instructions such as multiply and accumulate (MAC), the output of the multiplier is selected. For other instructions such as shift instructions, the value from the X bus (via the zero backfill logic) may be selected. The output of the multiplexer 305 is fed into the sign extend unit 315.

The sign extend unit 315 sign extends the output of the multiplexer from a 32 bit value to a 40 bit value. The sign extend unit 315 is illustrative only and this function may be implemented in a variety of ways. The sign extend unit 315 outputs a 40 bit value to a multiplexer 320.

The multiplexer 320 receives inputs from the sign extend unit 315 and the accumulators 345 and 350. The multiplexer 320 selectively outputs values to the input of a barrel shifter 330 based on control signals derived from the decoded instruction. The accumulators 345 and 350 may be any length. According to the embodiment of the present invention selected for illustration, the accumulators are 40 bits in length. A multiplexer 360 determines which accumulator 345 or 350 is output to the multiplexer 320 and to the input of an adder 340.

The instruction decoder sends control signals to the multiplexers 320 and 360, based on the decoded instruction. The control signals determine which accumulator is selected for either an add operation or a shift operation and whether a value from the multiplier or the X bus is selected for an add operation or a shift operation.

The barrel shifter 330 performs shift operations on values received via the multiplexer 320. The barrel shifter may perform arithmetic and logical left and right shifts and circular shifts where bits rotated out one side of the shifter reenter through the opposite side of the buffer. In the illustrated embodiment, the barrel shifter is 40 bits in length and may perform a 15 bit arithmetic right shift and a 16 bit left shift in a single cycle. The shifter uses a signed binary value to determine both the magnitude and the direction of the shift operation. The signed binary value may come from a decoded instruction, such as shift instruction or a multi-precision shift instruction. According to one embodiment of the invention, a positive signed binary value produces a right shift and a negative signed binary value produces a left shift.

The output of the barrel shifter 330 is sent to the multiplexer 355 and the multiplexer 370. The multiplexer 355 also receives inputs from the accumulators 345 and 350. The multiplexer 355 operates under control of the instruction decoder to selectively apply the value from one of the accumulators or the barrel shifter to the adder/subtractor 340 and the round and saturate logic 365.

The adder/subtractor 340 may select either accumulator 345 or 350 as a source and/or a destination. In the illustrated embodiment, the adder/subtractor 340 has 40 bits. The adder receives an accumulator input and an input from another source such as the barrel shifter 331, the X bus or the multiplier. The value from the barrel shifter 331 may come from the multiplier or the X bus and may be scaled in the barrel shifter prior to its arrival at the other input of the adder/subtractor 340. The adder/subtractor 340 adds to or subtracts a value from the accumulator and stores the result back into one of the accumulators. In this manner values in the accumulators represent the accumulation of results from a series of arithmetic operations. The round and saturate logic 365 is used to round 40 bit values from the accumulator or the barrel shifter down to 16 bit values that may be transmitted over the X bus for storage into a W register or data memory. The round and saturate logic has an output coupled to a multiplexer 370. The multiplier 370 may be used to select either the output of the round and saturate logic 365 or the output from a selected 16 bits of the barrel shifter 330 for output to the X bus.

Description of the Instruction Set

The designated instruction set according to the present invention is set forth in Table 1-1, which lists the instruction set in alphabetical order using mnemonics. The designated instruction set and descriptions of each designated instruction is presented in Appendix A. All of the tables are set forth at the end of the specification prior to the Figures. There are ninety four instructions, many of which have several addressing modes. To simplify the definition, each variant of an instruction is given a different “PLA mnemonic.” The detailed definitions of the instructions are listed by the PLA mnemonic in table Table 1-1 which lists the assembly syntax of each mnemonic, gives examples of usage of that syntax, gives the PLA mnemonic and references an appendix page at which a description of the instruction is found. Symbols used in the definitions of Table 1-1 are defined in Table 6-1 found in Appendix A. Appendix A comprises additional details describing the operation of each instruction and is incorporated by reference herein.

The instruction set coding is illustrated with reference to Table 1-2 which depicts the PLA mnemonic for each instruction, its assembly syntax, a corresponding description and its corresponding 24 bit opcode. Each of these opcodes is unique and provides a basis for the instruction fetch/decode 110 to derive and transmit different control signals to each processor element to selectively involve that element in the instruction processing. Table 1-3 sets forth status flag operations for the instruction set.

Table 4 depicts opcode field descriptions for the designated instruction set which are referenced in Table 1-2.

The instruction set may be grouped into the following functional categories: move instructions; math instructions; rotate/shift instructions; bit instructions; DSP instructions; skip instructions; flow instructions and stack instructions.

Table 1-5 depicts addressing modes for source registers. Table 1-6 depicts addressing modes for destination registers. Table 1-7 depicts offset addressing modes for WSO source registers. Table 1-8 depicts offset addressing modes for WSO destination registers. Tables 1-9 through 1-14 depict examples of prefetch operations and MAC operations.

The instruction field coding which breaks down the opcode into fields exploited by the instruction decoder is shown in Table 2-1. The opcodes are mapped to simplify the instruction decoding logic.

Collectively, the Tables illustrate the composition of the instruction op-code, the mnemonics that are assigned to the opcodes and details of the operation of the instruction. Even more details regarding each designated instruction and its exemplary uses according to an embodiment of the present invention are presented in Appendix A. Illustrative details regarding addressing modes are presented in Appendix B. An embodiment of timing for instructions within the instruction set is presented graphically in Appendix C. A detailed embodiment of an architecture for executing the instruction set is attached as Appendix D. The Appendices are incorporated by reference herein.

The following terms, used in the Appendices, are intended to specify an illustrative embodiment of a processor, such as a digital signal controller, that may be used to implement the instruction set according to the present invention: “RoadRunner” and “dsPIC.” Other embodiments may be implemented as a matter of design choice.

Instruction Flows

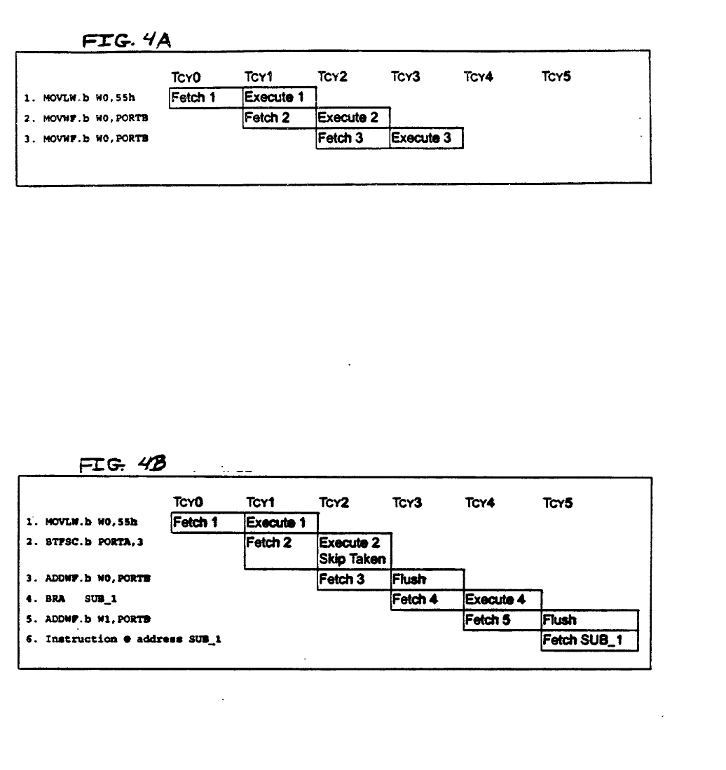

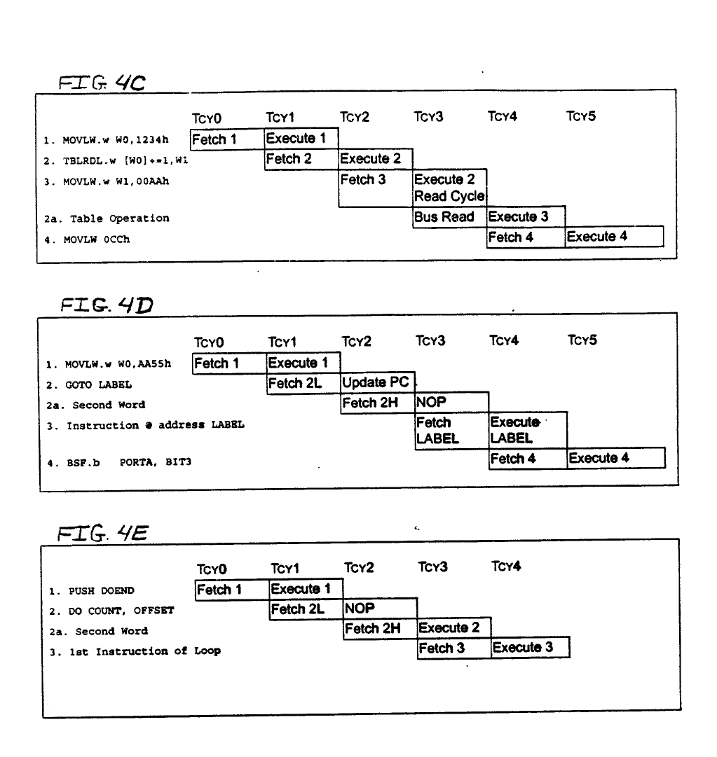

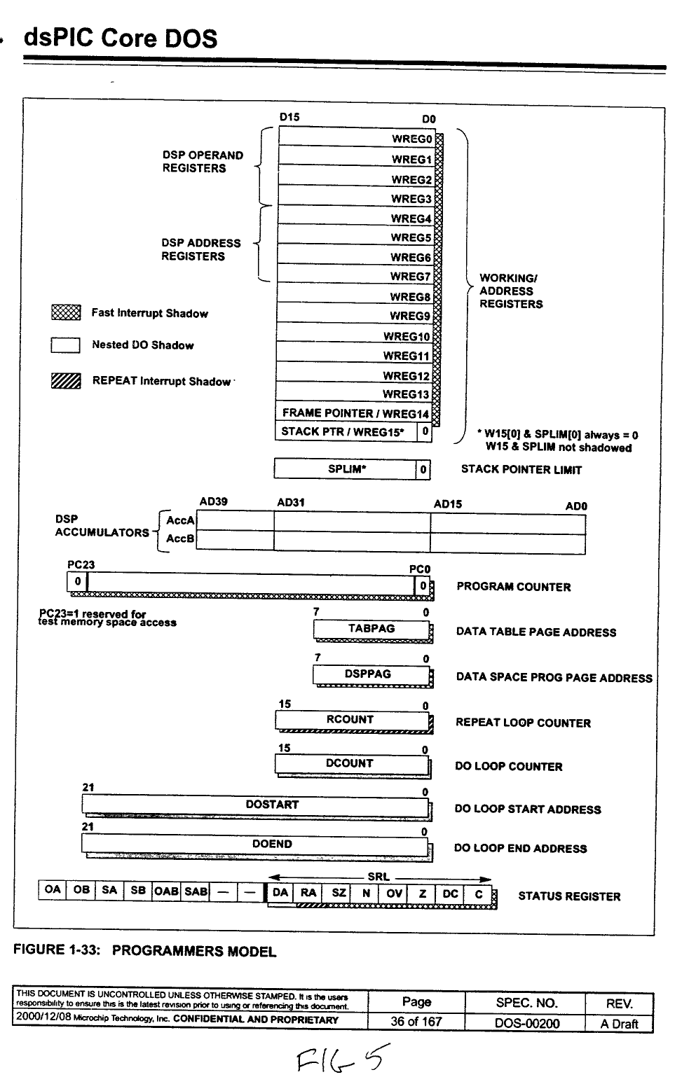

There are 5 types of instruction flows summarized below with reference to FIGS. 4A-4E.

The first type is a normal one word one cycle pipelined instruction. These instructions will take one effective cycle to execute as shown by the illustrative example in FIG. 4A.

The second type is a one word two cycle pipeline flush instruction. These instructions include the relative branches, relative call, skips and returns. When an instruction changes the PC (other than to increment it), the pipelined fetch is discarded. This makes the instruction take two effective cycles to execute as shown in FIG. 4B.

The third type is a table operation instruction. These instructions will suspend the fetching to insert a read or write cycle to the program memory. The instruction fetched while executing the table operation is saved for 1 cycle and executed in the cycle immediately after the table operation as shown in FIG. 4C.

The fourth type is a two word instruction for CALL and GOTO. In these instructions, the fetch after the instruction contains the remainder of the jump or call destination addresses. Normally, these instruction would require three cycles to execute, two for fetching the two instruction words and one for the subsequent pipeline flush. However, by providing a high speed path on the second fetch, the PC can be updated with the complete value in the first cycle of instruction execution, resulting in a two cycle instruction as shown in FIG. 4D.

The fifth type is a two word instruction for DO and DOW. In these instructions, the fetch after the instruction contains an address offset. This address offset is added to the first instruction address to generate the last loop instruction address.

Programmers Model

The programmers model of the processor is shown in FIG. 5 and consists of 16×16-bit working registers, 2×40-bit accumulators, status register, data table page register, data space program page register, DO and REPEAT registers, and program counter. The working registers can act as data, address or offset registers. All registers are memory mapped.

Most of these registers have a shadow register associated with them as shown in FIGS. 1-33. The shadow register is used as a temporary holding register and can transfer its contents to or from its host register upon some event occurring. None of the shadow registers are accessible directly. The following rules apply to register transfer into and out of shadows.

Fast Interrupts entry & exit

W0 to W14 shadows transferred

PC shadow transferred

TABPAG & DSPPAG shadows transferred

RCOUNT shadow transferred

SR[6:0] shadow bits transferred

Normal Interrupt Entry

RCOUNT shadow transferred

SR[6] shadow bit transferred

Nested DO

DOSTART, DOEND, DCOUNT shadows loaded

Byte instructions which target the working register array only effect the least significant byte of the target register. However, a consequence of memory mapped working registers is that both the least and most significant bytes can be manipulated through byte wide data memory space accesses.

Uninitialized Register Trap

The W register array (except W15) is not effected by a reset and therefore must be considered uninitialized until a written to. An attempt to read an uninitialized register for an address access will generate an address error trap (fetch of an uninitialized address). In this situation, the user will most likely choose to reset the application, though recovery may be possible through an examination of the problematic instruction (via the stacked return address).

This function is achieved through the addition of a single latch to each W register (W0 through W14). The latch is cleared by reset and set by the first write to the associated register and is described in the patent application entitled “Register Point Trap” incorporated by reference herein. When the latch is clear, a read of the corresponding register to either AGU will force an address error trap. W15 is initialized during reset and consequently does not require this feature.

Default W Register Selection

The default W register for all file register instructions is defined by the WD[3:0] field in the CORCON (CORE CONtrol register). This field is reset to 0x0000, corresponding to register W0. As most of the CORCON function relates to DSP operations, it is discussed in Section 2.0, DSP Engine.

Software Stack Pointer

W15 has been dedicated as the software stack pointer, and will be automatically modified by exception processing and subroutine calls and returns. However, W15 can be referenced by any instruction in the same manner as all other W registers. This simplifies reading, writing and manipulating the stack pointer (e.g. creating stack frames). In order to protect against misaligned stack accesses, W15[0] may be clear clear.

W15 may be initialized to 0x0200 during a reset. This will point to valid RAM in all derivatives and will guarantee stack availability for non-maskable trap exceptions or priority level 7 interrupts which may occur before the SP is set to where the user desires it. The user may reprogram the SP during initialization to any location within data space.

W14 may be dedicated as a stack frame pointer as defined by the LNK and ULNK instructions. However, W14 can be referenced by any instruction in the same manner as all other W registers.

The stack pointer points to the first available free word and fills working from lower towards higher addresses. It pre-decrements for stack pops (reads) and post increments for stack pushes (writes) as shown in FIGS. 1-32. Note that for a PC push during any CALL instruction, the MS-byte of the PC is zero extended before the push, ensuring that the MS-byte is always clear. The stack timing is shown in FIGS. 1-31. A PC push during exception processing may concatenate the SRL register to the MS-byte of the PC prior to the push.

Stack Pointer Overflow Trap

There is a stack limit register (SPLIM) associated with the stack pointer that is uninitialized at reset. SPLIM[15:1] is a 15-bit register. As is the case for the stack pointer, SPLIM[0] is forced to 0 because all stack operations must be word aligned.

The stack overflow check may not be enabled until a word write to SPLIM occurs after which time it can only be disabled by a reset. All EA's generated using W15 as Wsrc or Wdst (but not Wb) are compared against the value in SPLIM. Should the EA be greater than the contents of SPLIM, then a stack error trap is generated. This comparison is a subtraction, so the trap will occur for any SP greater than SPLIM. In addition, should the SP EA calculation wrap over the end of data space (0xFFFF), AGU X will generate a carry signal which will also cause a stack error trap (if the SPLIM register has been initialized.

Stack Pointer Underflow Trap

The stack is initialized to 0x0200 during reset. A simple stack underflow mechanism is provided which will initiate a stack error trap should the stack pointer address ever be less than 0x0200.

Status Register

The status register is a 16-bit status register (SR), the LS-byte of which is referred to as the lower status register (SRL). A detailed table showing the arrangement of the SR register is set forth below.

Upper Half:

| R/W-0 | R/W-0 | R/W-0 | R/W-0 | R/W-0 | R/W-0 | U | U |
|---|---|---|---|---|---|---|---|
| OA | OB | SA | SB | OAB | SAB | — | — |
| bit 15 | | | | | | | bit 8 |

Lower Half:

| R-0 | R-0 | R/W-0 | R/W-0 | R/W-0 | R/W-0 | R/W-0 | R/W-0 |
|---|---|---|---|---|---|---|---|
| DA | RA | SZ | N | OV | Z | DC | C |
| bit 7 | | | | | | | bit 0 |

The SRL contains the MCU ALU operation status flags (including a new ‘sticky Z’ (SZ) bit described in the application entitled “Sticky Zero Bit Flag” incorporated by reference herein and the REPEAT and DO loop active status bits. During exception processing, SRL may be concatenated with the MS-byte of the PC to form a complete word value which is then stacked.

The upper byte of the SR may contains the DSP Adder/Subtractor status bits. All SR bits are read/write except for the DA and RA bits which are read only because accidentally setting them could cause erroneous operation (include inhibiting PC increments). When the memory mapped SR is the destination address for an operation which affects any of the SR bits, data writes are disabled to all bits. The bits of the SR are summarized below.

| | | |
|---|---|---|
| bit 15 | OA: | Accumulator A Overflow Status |
| | 1= | Accumulator A overflowed |
| | 0= | Accumulator A not overflowed |
| bit 14 | OB: | Accumulator B Overflow Status |
| | 1= | Accumulator B overflowed |
| | 0= | Accumulator B not overflowed |
| bit 13 | SA: | Accumulator A Saturation ‘Sticky’ Status |
| | 1= | Accumulator A is saturated or has been saturated at some time |
| | 0= | Accumulator A is not saturated |
| bit 12 | SB: | Accumulator B Saturation ‘Sticky’ Status |
| | 1= | Accumulator B is saturated or has been saturated at some time |
| | 0= | Accumulator B is not saturated |
| bit 11 | OAB: | OA OB Combined Accumulator Overflow Status |
| | 1= | Accumulators A or B have overflowed |
| | 0= | Neither Accumulators A or B have overflowed |
| bit 10 | SAB: | SA SB Combined Accumulator ‘Sticky’ Status |
| | 1= | Accumulators A or B are saturated or have been saturated at some time in |
| | | the past |
| | 0= | Neither Accumulator A or B are saturated |
| bit 9-8 | Unused | |
| bit 7 | DA: | DO Loop Active |
| | 1= | DO loop in progress |
| | 0= | DO loop not in progress |
| bit 6 | RA: | REPEAT Loop Active |
| | 1= | REPEAT loop in progress |
| | 0= | REPEAT loop not in progress |
| bit 5 | SZ: | MC ALU ‘sticky Zero bit |
| | 1= | An operation which effects the Z bit has set it at some time in the past |
| | 0= | The most recent operation which effects the Z bit has cleared it (i.e. a non- |
| | | zero result) |
| bit 4 | N: | MCU ALU Negative bit |
| bit 3 | OV: | MCU ALU Overflow bit |
| bit 2 | Z: | MCU ALU Zero bit |
| bit 1 | DC: | MCU ALU Half Carry/Borrow bit |
| bit 0 | C: | MCU ALU Carry/Borrow bit |

Legend
R = Readable bit
W = Writable bit
U = Unimplemented bit, read as ‘0’
-n = Value at POR
1 = bit is set
0 = bit is cleared
x = bit is unknown

Instruction Addressing Modes

The basic set of addressing modes shown in Table 4-1. Note that, ‘Wn+=’ indicates that the contents of Wn is added to something to form the effective address which is then written back into Wn. ‘Wn+’ indicates that the contents of Wn is added to something to form the effective address but the contents of Wn remain unchanged.

The addressing modes in form the basis of three groups of addressing modes optimized to support specific instruction features. They are MODE1, MODE2 AND MODE3. The DSP MAC and derivative instructions are an exception where the addressing modes are encoded differently. This set of addressing modes is referred to as MODE4.

Note: Reference DSP CORE DOS FOR MODE4

| Addressing Mode | Function | Description |
|---|---|---|
| Register Direct | EA = Wn | Wn is the EA |
| Register Indirect | EA = [Wn] | The contenst of Wn forms the EA |
| Register Indirect Post - | EA = [Wn] + = 1 | The contents of Wn forms the EA |
| modified | | which is post-modified by a constant |
| | | value |
| Register Indirect Pre-modified | EA = [Wn + = 1] | Wn is pre-modified by a signed |
| | EA = [Wn − = 1] | constant value to form the EA |
| Register Indirect with Register | EA = [Wn + Wb] | The sum of Wn and Wb forms the EA |
| Offset | | |
| Register Indirect with Constant | EA = [Wn + | The sum of Wn and a signed constant |
| Offset | constant] | value forms the EA |

EA is defined as the effective address. All address modification values (except Wb) are scaled for word access.

Addressing Modes

All but few instructions support both 8-bit and 16-bit operand data sizes. In order to efficiently accommodate this requirement, effective addresses are byte aligned. As the data space is 16-bits wide, the following consequences must be understood.

a. Mis-aligned word accesses are not supported. All word effective addresses must be even (the LS-bit of the EA is ignored by the data space memory).

b. The LS-bit of the effective address is used to select which byte (upper or lower) is multiplexed onto bits [7:0] of the data bus for byte sized accesses.

c. Post and pre-modification of a register by a constant value to create a new effective address must take into account of the data size accessed. All constant values, whether implied (e.g. post-inc) or declared (e.g. post-modify with S5lit) are scaled by a factor of 2 for word accesses. For example:

[Ws]+=1 will post modify data source pointer Ws by 1 for a byte access, and by 2 for a word access.

[Ws]+=Slit5 will post modify data source pointer Ws by Slit5 for byte accesses and Slit5<<1 (shift left by 1) for word accesses.

Address modification values (except Wb) are scaled for word access.

While specific embodiments of the invention have been illustrated and described, it will be understood by those having ordinary skill in the art that changes may be made to those embodiments without departing from the spirit and scope of the invention.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A processor for executing an instruction set comprising the designated instruction set, the processor comprising:
a program memory for storing program instructions including instructions from the designated instruction set;
a program counter for determining current instruction for processing;
registers for storing operand data specified by the program instructions; and
at least one instruction execution unit for executing the current instruction.

2. The processor according to claim 1, wherein the at least one execution unit includes a digital signal processing engine.

3. The processor according to claim 1, wherein the at least one execution unit includes an arithmetic logic unit.

4. The processor according to claim 1, wherein each designated instruction is identified to the processor by the designated encoding.
